(19) United States
(12) Patent Application Publication
(10) Pub. No.: US 2026/0175979 A1
(43) Pub. Date: Jun. 25, 2026

(54) LAVATORY COMPARTMENT STRUCTURE OF AIRCRAFT

(71) Applicant: JAMCO CORPORATION, Mitaka-shi, Tokyo (JP)

(72) Inventors: Masahiro KOBAYASHI, Tachikawa-shi, Tokyo (JP); Toshihiro MITSUI, Tachikawa-shi, Tokyo (JP)

(21) Appl. No.: 19/104,509

(22) PCT Filed: Apr. 8, 2024
(86) PCT No.: PCT/JP2024/014215

§ 371 Date: Feb. 18, 2025

(51) Int. Cl. B60R 5/04; A61G 5/10; A61G 7/10; B60N 2/005; B60P 7/08; B60R 21/213; B64D 11/00; B64D 11/02; B64D 11/04; B64D 11/06; B64F 5/00; E03D 9/05; E03D 9/08; E03D 11/00; E03D 11/02; E05B 39/04

(52) U.S. Cl. CPC B64D 11/02; B64D 11/0023; E05B 39/04

(57) ABSTRACT

A lavatory compartment structure of an aircraft capable of realizing convenience of passengers using wheelchairs etc. while ensuring privacy without reducing the number of lavatory compartments is provided. In a lavatory compartment structure that may be installed of an aircraft, by operating a first operation member, the first operation member may be shifted to either an engaged state in which the first operation member is engaged to a second operation member or a separated state in which the first operation member is separated from the second operation member, and, in the engaged state, the second operation member may not be operated to move a locking portion from a lock position to an unlock position, and in the separated state, the second operation member may be operated to move the locking portion from the lock position to the unlock position.

### TECHNICAL FIELD

The present invention relates to a lavatory compartment structure of aircrafts.

### BACKGROUND ART

Currently, passenger aircrafts having two or more aisles, called wide-body aircrafts, are required by law to have one or more lavatories, i.e., toilet booths on the aircraft, which may be used by passengers on wheelchairs. A common lavatory compartment for passengers is relatively small, for example having an external dimension of 38 in.×41 in., that is, 965 mm×1041 mm, in planar view, so it is difficult for passengers on wheelchairs to enter such a compartment.

Therefore, in order to enable easy use of the lavatory by passengers on wheelchairs, there are ideas on installing a large-sized compartment having an external dimension of 56 in.×41 in., that is, 1422 mm×1041 mm, which is somewhat larger than the common lavatory compartment, or to remodel a partition wall between compartments of two adjacently-arranged standard lavatories into a sliding door and connect the two lavatory compartments by opening the sliding door when a passenger on a wheelchair uses the lavatory, as disclosed in Patent Document 1.

### CITATION LIST

### Patent Document

[Patent Document 1] Japanese Patent Application Laid-Open Publication No. H10-121754

### DISCLOSURE OF THE INVENTION

### Problems to be Solved by the Invention

Since the space within a body of the aircraft is limited, if a large-sized lavatory compartment is to be installed for passengers using wheelchairs, the number of lavatory compartments will be reduced, such that convenience of passengers is deteriorated. Meanwhile, according to the lavatory structure of Patent Document 1, the number of lavatory compartments may be maintained, but there are drawbacks described below.

According to the lavatory structure of Patent Document 1, locking of the door of the lavatory compartment and the sliding door is enabled in an interlocked manner. Specifically, a configuration is adopted in which the locking of the sliding door is not enabled when the door of the lavatory compartment is not locked. Therefore, if neither of the lavatory compartments are used, the locking of the door from the inner side is not performed, such that a passenger may enter the lavatory compartment on the wheelchair and open the sliding door to use the lavatory.

Meanwhile, according to the lavatory structure of Patent Document 1, if the opening and closing of the sliding door is not desired, the sliding door must be locked by a separate operation as the locking of the respective doors, such that it is not convenient. If a user forgets to lock the sliding door, the passenger in the adjacent lavatory compartment may erroneously open the sliding door, and privacy cannot be ensured.

The present invention aims at solving such problems, and provides a lavatory compartment structure of an aircraft without reducing the number of lavatory compartments while realizing convenience of passengers using wheelchairs etc., and ensuring privacy.

### Means of Solving the Problems

In order to achieve the objects described above, a lavatory compartment structure that may be installed on an aircraft according to the present invention includes:
a first lavatory compartment surrounded by a first housing;
a second lavatory compartment adjacent to the first lavatory compartment and surrounded by a second housing;
a movable wall that is movable between a closed position of closing a space between the first lavatory compartment and the second lavatory compartment and an open position of opening the space between the first lavatory compartment and the second lavatory compartment; and
a main lock mechanism of the movable wall,
wherein the first housing and the second housing constitute a lavatory housing,
wherein the main lock mechanism includes:
a first operation member that is operable from one side of either the first lavatory compartment or the second lavatory compartment;
a second operation member that is operable from the other side of the first lavatory compartment or the second lavatory compartment; and
a locking portion connected to the second operation member and that is movable between a lock position preventing movement of the movable wall with respect to the lavatory housing, and an unlock position enabling movement of the movable wall with respect to the lavatory housing,
wherein, by operating the first operation member, the first operation member may be shifted to either an engaged state in which the first operation member is engaged to the second operation member or a separated state in which the first operation member is separated from the second operation member, and
wherein, in the engaged state, the second operation member may not be operated to move the locking portion from the lock position to the unlock position, and in the separated state, the second operation member may be operated to move the locking portion from the lock position to the unlock position.

### Effects of the Invention

According to the present invention, a lavatory compartment structure of an aircraft that enables to realize convenience of passengers using wheelchairs etc. while ensuring privacy without reducing the number of lavatory compartments may be provided.

### BRIEF DESCRIPTION OF THE DRAWINGS

FIG. 1 is a plan view of a vicinity of a lavatory of an aircraft in enlarged view.

FIG. 2 is a plan view of a lavatory compartment structure according to an embodiment of the present invention in enlarged view, showing a state in which a movable wall is moved to a closed position.

FIG. 3 is a plan view illustrating in enlarged view the lavatory compartment structure according to the embodiment of the present invention, showing a state in which the movable wall is started to be opened.

FIG. 4 is a plan view illustrating in enlarged view the lavatory compartment structure according to the embodiment of the present invention, showing a state in which the movable wall is moved to an intermediate position between the closed position and an open position.

FIG. 5 is a plan view illustrating in enlarged view the lavatory compartment structure according to the embodiment of the present invention, showing a state in which the movable wall is moved to the open position.

FIG. 6 is a view of an intermediate wall taken in an arrow A direction of FIG. 2.

FIG. 7 is an enlarged view of a vicinity of an upper end of the movable wall viewed from a second lavatory compartment side, showing a state in which an access door is closed.

FIG. 8 is an enlarged view of the vicinity of the upper end of the movable wall viewed from the second lavatory compartment side, showing a state in which the access door is opened.

FIG. 9 is an enlarged view of the vicinity of the upper end of the movable wall viewed from a first lavatory compartment side, showing a state in which the access door is closed.

FIG. 10 is an enlarged view of the vicinity of the upper end of the movable wall viewed from the first lavatory compartment side, showing a state in which the access door is opened.

FIG. 11 is an enlarged view of a vicinity of a lower end of the movable wall viewed from the second lavatory compartment side, showing a locked state of a second lock mechanism.

FIG. 12 is an enlarged view of the vicinity of the lower end of the movable wall viewed from the second lavatory compartment side, showing an unlocked state of the second lock mechanism.

FIG. 13 is a view illustrating a first lock mechanism arranged within a space on an inner side of a second panel viewed from the first lavatory compartment side, showing a locked state.

FIG. 14 is a view illustrating the first lock mechanism arranged within the space on the inner side of the second panel viewed from the first lavatory compartment side, showing an unlocked state.

FIG. 15A is a view illustrating the first lock mechanism arranged within the space on the inner side of the second panel viewed from the second lavatory compartment side, showing an engaged state of a first operation member.

FIG. 15B is a view illustrating the first lock mechanism arranged within the space on the inner side of the second panel viewed from the second lavatory compartment side, showing a separated state of the first operation member.

FIG. 16A is a view illustrating the first lock mechanism arranged within the space on the inner side of the second panel viewed from the second lavatory compartment side, showing a locked state of a second operation member.

FIG. 16B is a view illustrating the first lock mechanism arranged within the space on the inner side of the second panel viewed from the second lavatory compartment side, showing an unlocked state of the second operation member.

FIG. 17 is a view schematically illustrating the first lock mechanism viewed from the second lavatory compartment side, showing an engaged state of the first operation member.

FIG. 18 is a view schematically illustrating the first lock mechanism and the second lock mechanism viewed from the first lavatory compartment side, showing a separated state of the first operation member and the locked state of the second operation member.

FIG. 19 is a view schematically illustrating the first lock mechanism and the second lock mechanism viewed from the first lavatory compartment side, showing the unlocked state of the second operation member.

FIG. 20A is a view illustrating a third lock mechanism arranged within a space on an inner side of a first panel viewed from a second lavatory compartment side, showing a locked state.

FIG. 20B is a view illustrating the third lock mechanism arranged within the space on the inner side of the first panel viewed from the second lavatory compartment side, showing an unlocked state.

FIG. 21 is a view illustrating the third lock mechanism viewed from the second lavatory compartment side, showing the locked state.

FIG. 22 is a view illustrating the third lock mechanism viewed from the second lavatory compartment side, showing the unlocked state.

FIG. 23 is a view illustrating an enlarged view of a vicinity of a center of a side portion of the movable wall viewed from the first lavatory compartment side, showing a state where the access door is closed.

FIG. 24 is a view illustrating an enlarged view of the vicinity of the center of the side portion of the movable wall viewed from the first lavatory compartment side, showing a state where the access door is opened.

FIG. 25A is a view illustrating a fourth lock mechanism arranged within a space on an inner side of the first panel viewed from the first lavatory compartment side, showing a locked state.

FIG. 25B is a view illustrating the fourth lock mechanism arranged within the space on the inner side of the first panel viewed from the first lavatory compartment side, showing an unlocked state.

### MODE FOR CARRYING OUT THE INVENTION

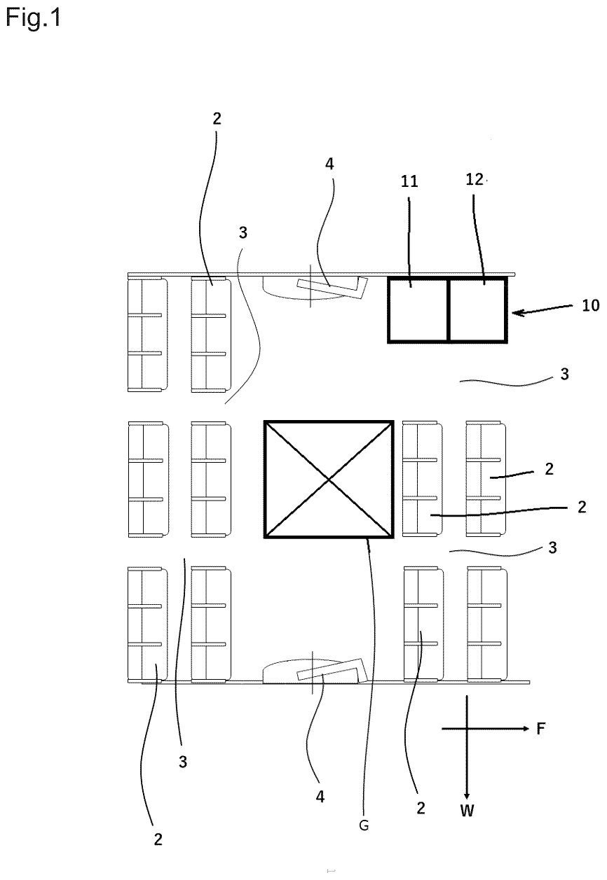

Now, a lavatory compartment structure that may be installed in an aircraft according to an embodiment of the present invention will be described with reference to the drawings. FIG. 1 is a plan view illustrating a vicinity of a lavatory of an aircraft 1 in enlarged view. A direction of travel of the aircraft is shown by arrow F in FIG. 1, and a width direction is shown by arrow W.

A cabin of the aircraft 1 has seat units 2 including three seats aligned in the width direction W, which are further aligned in three rows in the width direction W, and vertical aisles 3 are arranged between the seat units 2.

Aircraft doors 4 are arranged on both sides of the aircraft 1, with an area formed between the two aircraft doors 4 having a relatively wide space between the seat units 2 in the direction of travel F, forming an aisle referred to as a cross aisle connecting the aircraft doors 4 on both sides. In the present embodiment, a galley G is arranged on the cross aisle. Further, in a vicinity of one of the aircraft doors 4, a lavatory compartment structure 10 is installed next to the aircraft body, instead of the seat units 2. The lavatory compartment structure 10 may be installed on locations other than this location.

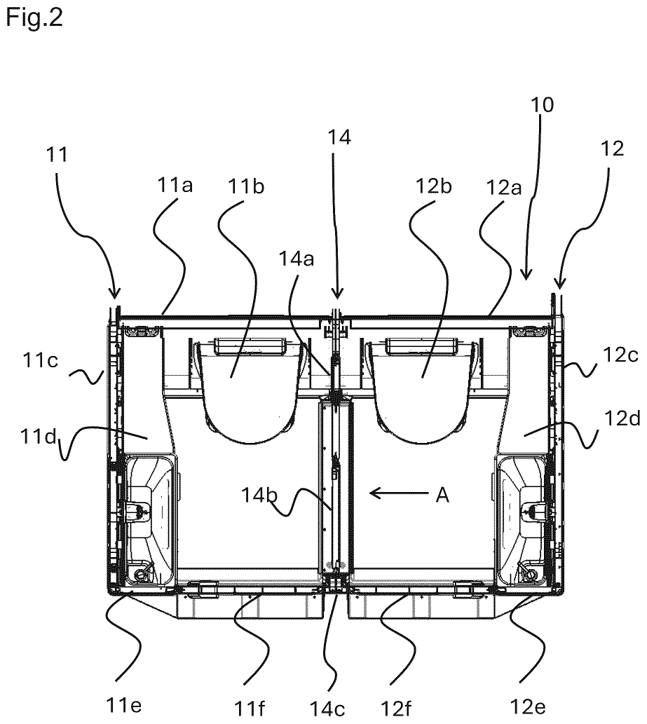

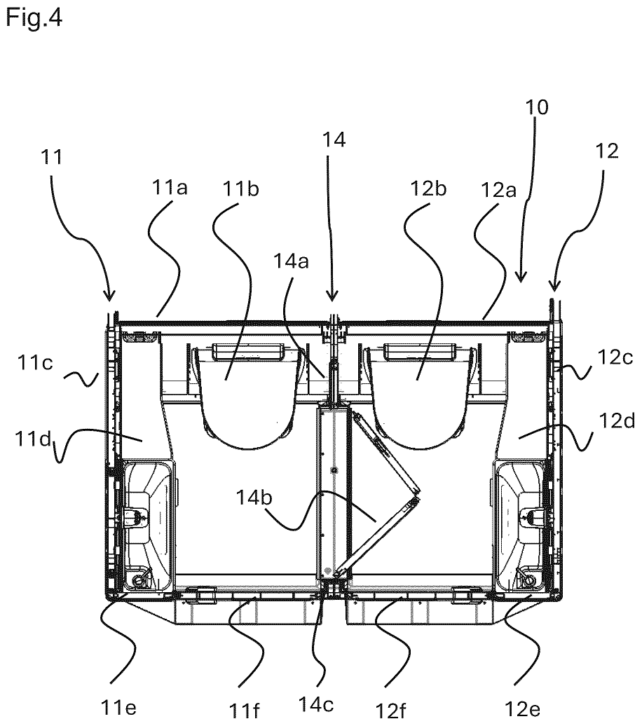

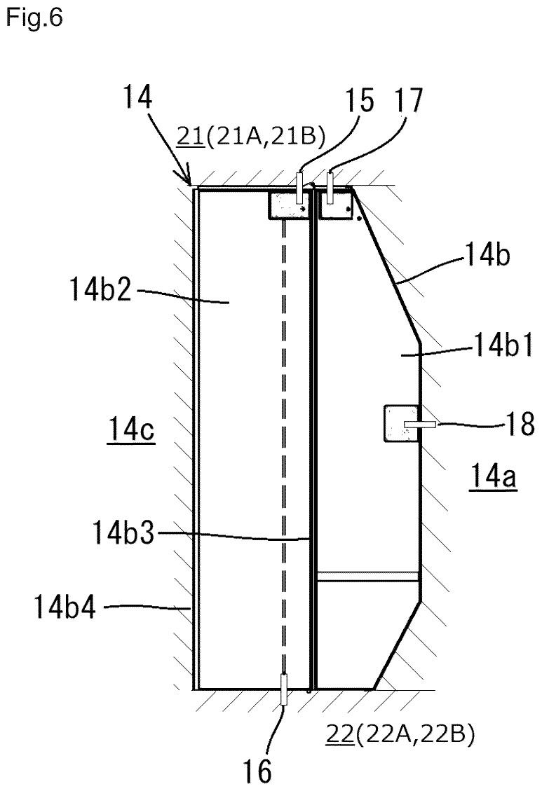

FIGS. 2 to 5 are plan views illustrating the lavatory compartment structure 10 according to the present embodiment in enlarged view. The lavatory compartment structure 10 includes two compartments, which are a first lavatory compartment 11 and a second lavatory compartment 12, aligned along the width direction W. The first lavatory compartment 11 includes a rear wall 11a, a front wall lie, a side wall 11c, a ceiling 21A (refer to FIG. 6), and a floor 22A, which are joined together to form a first housing surrounding the first lavatory compartment 11. Further, the second lavatory compartment 12 includes a rear wall 12a, a front wall 12e, a side wall 12c, a ceiling 21B (refer to FIG. 6), and a floor 22B, which are joined together to form a second housing surrounding the second lavatory compartment 12.

The first housing and the second housing are individually carried into a body of the aircraft 1, joined together with an intermediate wall 14 interposed therebetween, and are installed as the lavatory compartment structure 10 having a hexahedron shape. In this state, the first housing and the second housing are joined and integrated, by which a lavatory housing is formed. The floors 22A and 22B in the lavatory housing are each fixed at four positions to the body, and the ceilings 21A and 21B are each fixed at one location to the body. In the following description, it is assumed that the ceiling 21A and the ceiling 21B are connected and integrated to constitute a ceiling 21, and the floor 22A and the floor 22B are connected and integrated to constitute a floor 22.

In the first lavatory compartment 11, a toilet bowl 11b is disposed so as to be in contact with the rear wall 11a, and a washstand 11d is disposed on the side wall 11c on an opposite side from the second lavatory compartment 12. The washstand 11d extends from the rear wall 11a to the front wall 11e facing an aisle 3. The front wall 11e extends from the side wall 11c to a predetermined distance in parallel with the rear wall 11a, and may be connected to a lavatory door 11f. The lavatory door 11f is connected by a hinge to a supporting wall 14c, and may open and close the space between the front wall 11e and the supporting wall 14c by pivoting.

In the second lavatory compartment 12, a toilet bowl 12b is provided so as to be in contact with the rear wall 12a aligned with the rear wall 11a, and a washstand 12d is disposed on the side wall 12c parallel to the side wall 11c on an opposite side from first second lavatory compartment 11. The washstand 12d extends from the rear wall 12a to the front wall 12e facing the aisle 3. The front wall 12e extends from the side wall 12c to a predetermined distance in parallel with the rear wall 12a opposing the front wall 12e, and may be connected to a lavatory door 12f. The lavatory door 12f is connected by a hinge to the supporting wall 14c, and may open and close the space between the front wall 12e and the supporting wall 14c by pivoting.

The lavatory compartments 11 and 12 may have symmetrical shapes interposing the intermediate wall 14 illustrated in FIG. 2, wherein the toilet bowls and the washstands are arranged symmetrically interposing the intermediate wall 14. The intermediate wall 14 separates the lavatory compartments 11 and 12.

The intermediate wall 14 includes a fixed wall 14a that extends in parallel with the side walls 11c and 12c and that is fixed and connected to the rear walls 11a and 12a, a movable wall 14b that is movable with respect to the fixed wall 14a, and the supporting wall 14c on which an end edge of the movable wall 14b is supported pivotally.

FIG. 6 is a view illustrating the intermediate wall 14 in the arrow A direction of FIG. 2, wherein a first lock mechanism 15, a second lock mechanism 16, a third lock mechanism 17, and a fourth lock mechanism 18 are schematically illustrated. Upper and lower ends of the fixed wall 14a and the supporting wall 14c are fixed to the ceiling 21 and the floor 22. The first lock mechanism 15 and the second lock mechanism 16 constitute a main lock mechanism, and the third lock mechanism 17 and the fourth lock mechanism 18 constitute a sub-lock mechanism.

The movable wall 14b is a so-called accordion type folding door, including a first panel 14b1 having a hexagonal shape, a second panel 14b2 having a rectangular shape, a first hinge 14b3 that connects the first panel 14b1 and the second panel 14b2 in a manner capable of pivoting about an axis perpendicular to the floor 22, and a second hinge 14b4 that connects the second panel 14b2 and the supporting wall 14c in a manner capable of pivoting about an axis perpendicular to the floor 22. End edges where the first panel 14b1 and the second panel 14b2 oppose each other extend perpendicularly from the ceiling 21 to the floor 22.

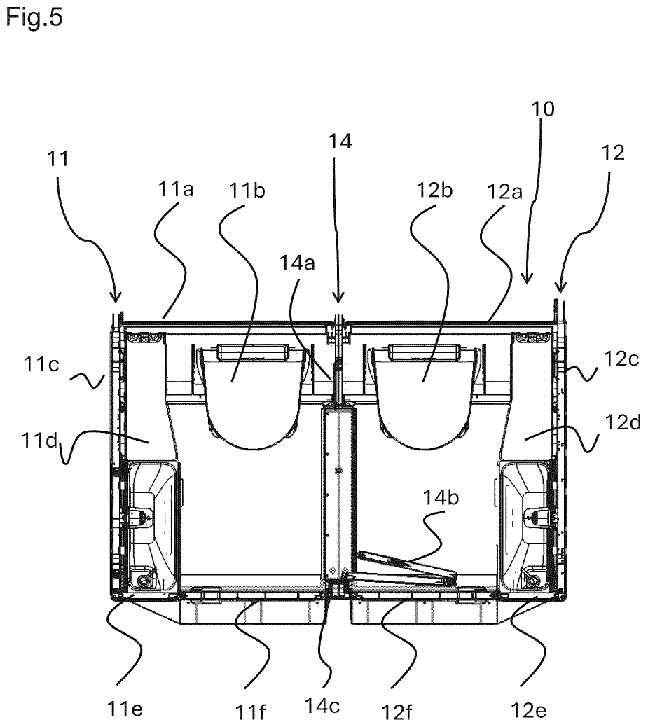

The first panel 14b1 and the second panel 14b2 may pivot relatively with respect to each other by the first hinge 14b3 so as to protrude toward the second lavatory compartment 12 side and further folded such that the panels are positioned adjacently with each other. Further, the second panel 14b2 may pivot with respect to the supporting wall 14c via the second hinge 14b4, and by pivoting, the second panel 14b2 may be moved to a position adjacent to the lavatory door 12f. Thereby, the movable wall 14b may move between a closed position illustrated in FIG. 2 and an open position illustrated in FIG. 5.

Further, in the closed position illustrated in FIG. 6, the first panel 14b1 of the movable wall 14b is positioned without a gap formed between the end edge of the fixed wall 14a, the ceiling 21, and the floor 22, and the second panel 14b2 is positioned without a gap formed between the end edge of the supporting wall 14c, the ceiling 21, and the floor 22.

The first lock mechanism 15 is disposed near the upper end of the second panel 14b2, and the second lock mechanism 16 is disposed near the lower end of the second panel 14b2. Further, the third lock mechanism 17 is disposed near the upper end of the first panel 14b1, and the fourth lock mechanism 18 is disposed near the end edge of the first panel 14b1.

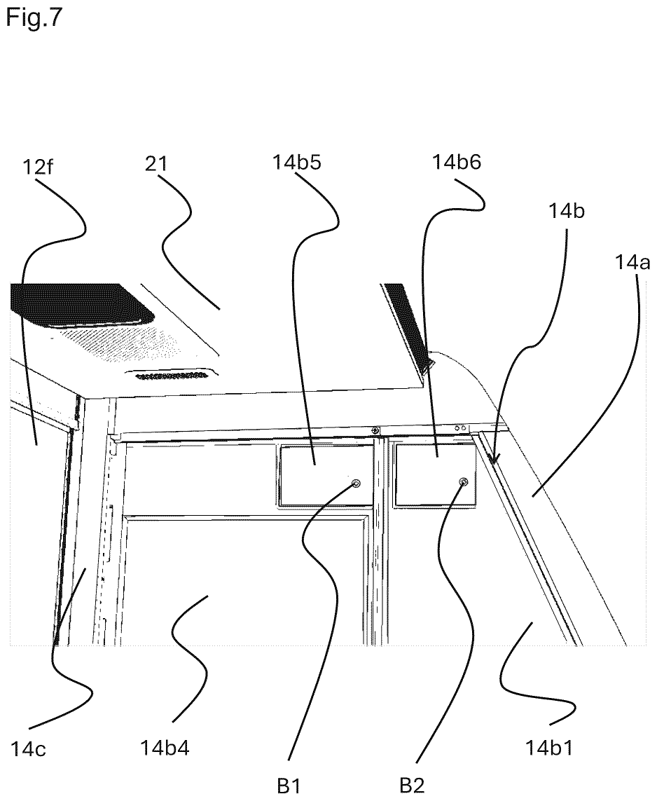

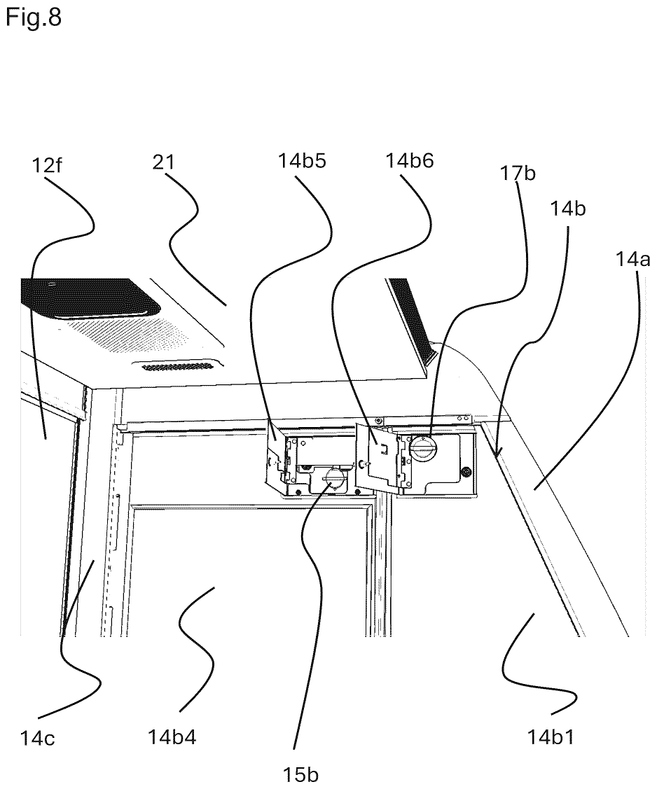

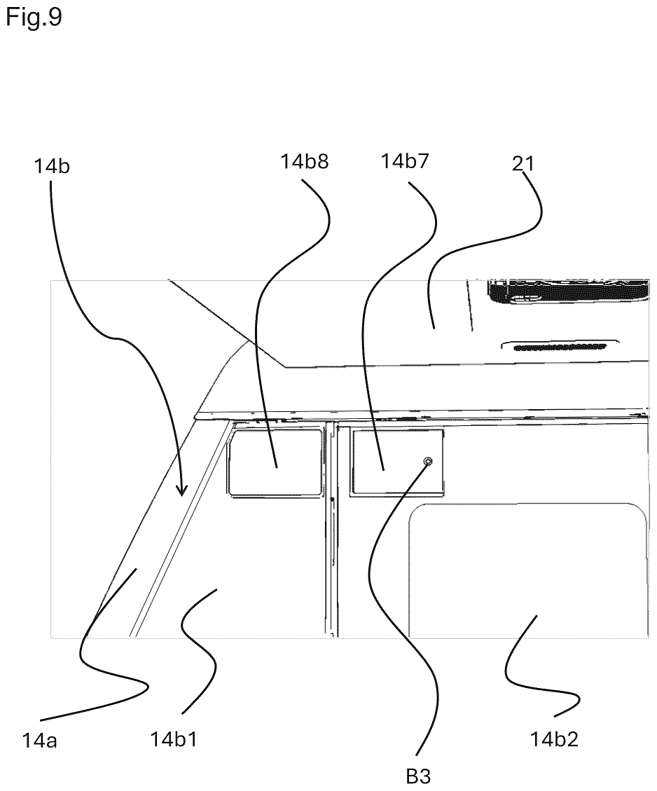

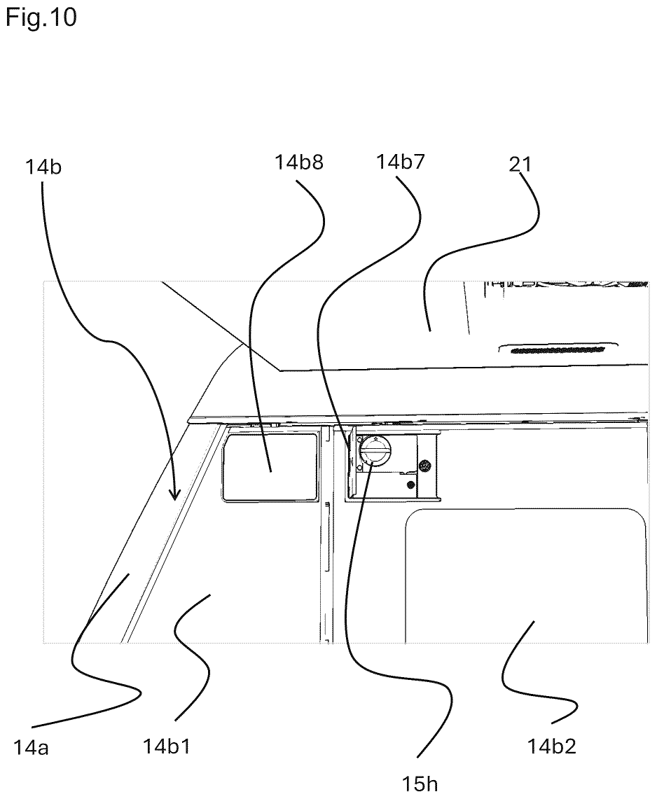

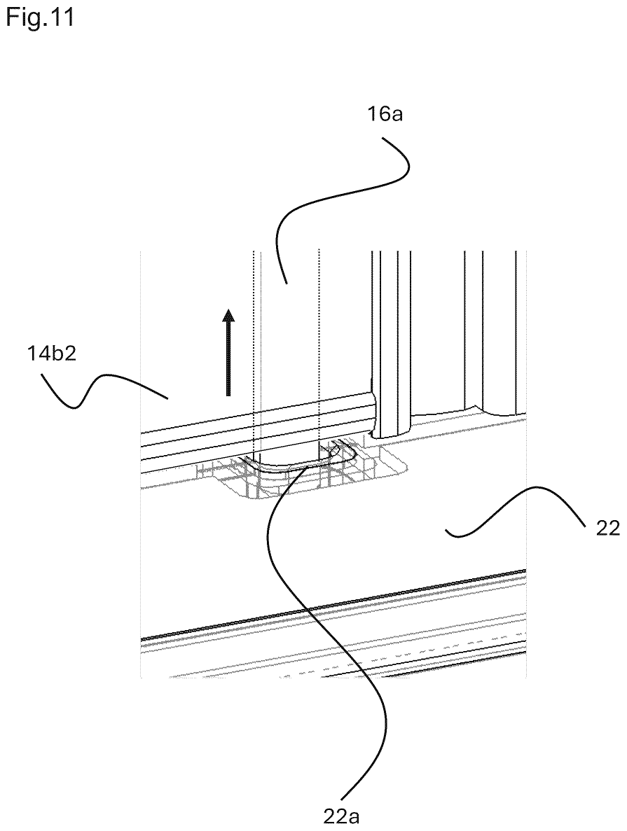

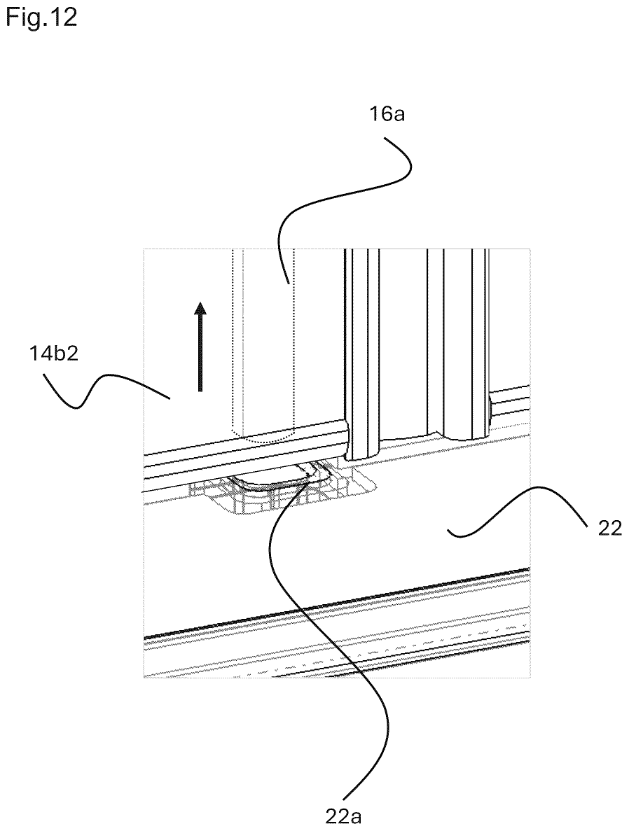

FIGS. 7 and 8 are views illustrating a vicinity of an upper end of the movable wall 14b in enlarged view, taken from the second lavatory compartment 12 side. FIGS. 9 and 10 are views illustrating a vicinity of the upper end of the movable wall 14b in enlarged view, taken from the first lavatory compartment 11 side. FIGS. 11 and 12 are views illustrating a vicinity of the lower end of the movable wall 14b in enlarged view, taken from the second lavatory compartment 12 side.

As illustrated in FIG. 7, the second panel 14b2 includes a small-sized first access door 14b5 near the upper end of the second panel 14b2 positioned adjacent to the first panel 14b1 on the side wall of the second lavatory compartment 12. Further, the first panel 14b1 includes a small-sized second access door 14b6 near the upper end of the first panel 14b1 positioned adjacent to the second panel 14b1 on the side wall of the second lavatory compartment 12.

By pushing respective buttons B1 and B2, locking mechanisms not shown are released, and the first access door 14b5 and the second access door 14b6 will be in an open state as illustrated in FIG. 8 with respect to the second panel 14b2 and the first panel 14b1, such that cabin attendants etc. may access the interior thereof. Further, by closing each of the first access door 14b5 and the second access door 14b6 with respect to the second panel 14b2 and the first panel 14b1 and pushing the respective buttons B1 and B2, the locking mechanism is activated. Thereby, as illustrated in FIG. 7, the first access door 14b5 and the second access door 14b6 are maintained in a closed state with respect to the second panel 14b2 and the first panel 14b1, and cabin attendants etc. may not access the interior thereof. The first lock mechanism 15 is arranged in a space on the inner side of the first access door 14b5, and the third lock mechanism 17 is arranged in a space on the inner side of the second access door 14b6.

As illustrated in FIG. 9, the second panel 14b2 includes a small-sized third access door 14b7 near the upper end of the second panel 14b2 positioned adjacent to the first panel 14b1 on the side wall of the first lavatory compartment 11. The third access door 14b7 is arranged to correspond to the first access door 14b5. That is, the first lock mechanism 15 is arranged on an interior of the second panel 14b2 between the first access door 14b5 and the third access door 14b7. By pushing a button B3, a locking mechanism not shown is released, and the third access door 14b7 will be in an open state as illustrated in FIG. 10 with respect to the second panel 14b2, such that cabin attendants etc. may access the interior thereof.

Further, by closing the third access door 14b7 with respect to the second panel 14b2 and pushing the button B3, the locking mechanism is activated, and the third access door 14b7 will be maintained in a state closed with respect to the second panel 14b2, as illustrated in FIG. 9, such that cabin attendants etc. may not access the interior thereof. It may be possible to dispose a door 14b8 for inspection in an openable and closable manner in correspondence to the second access door 14b6 on the first panel 14b1 on the first lavatory compartment 11 side.

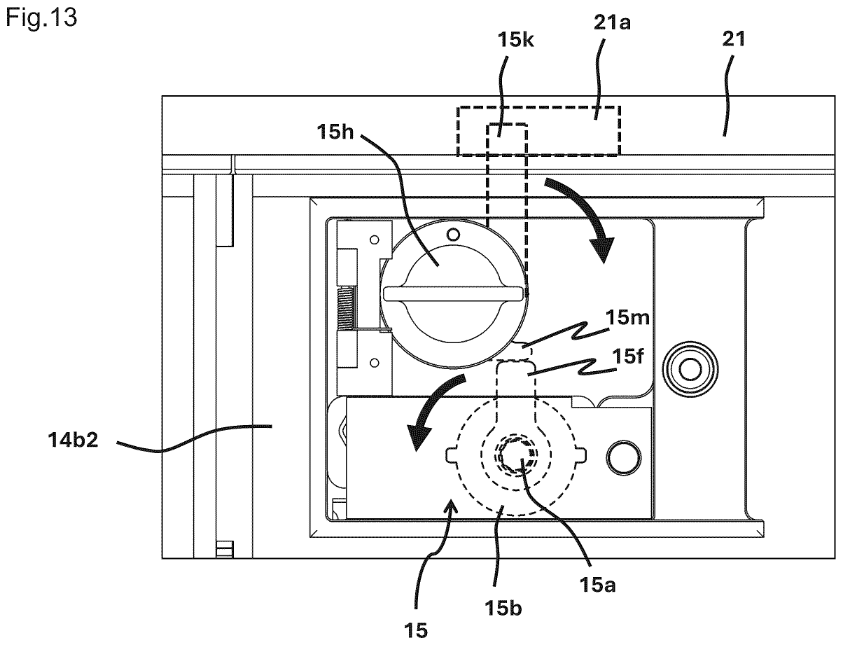

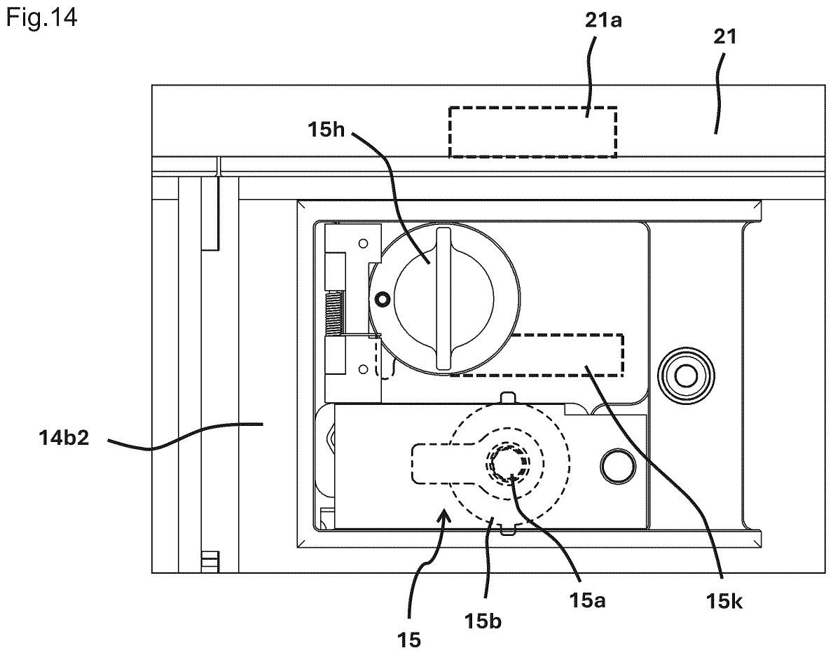

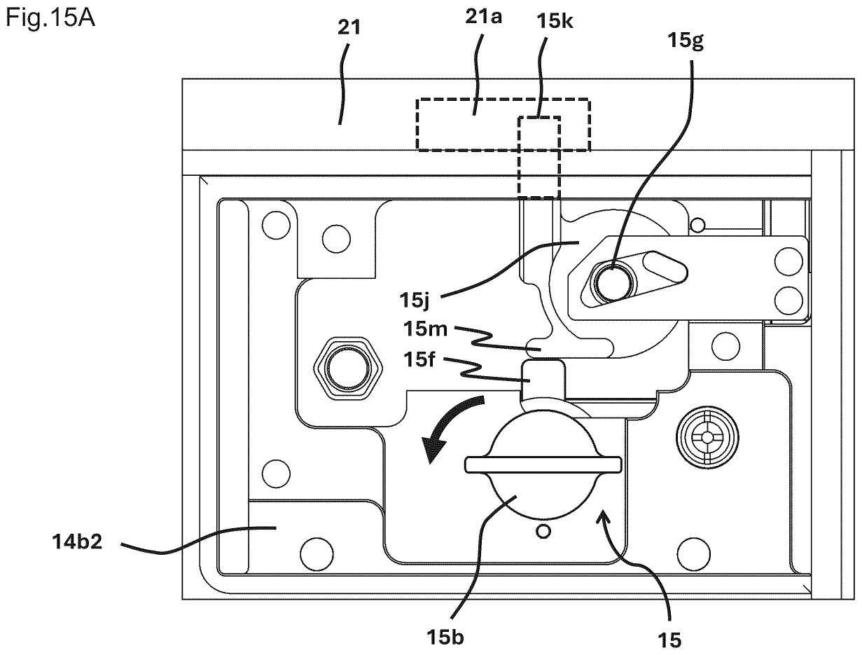

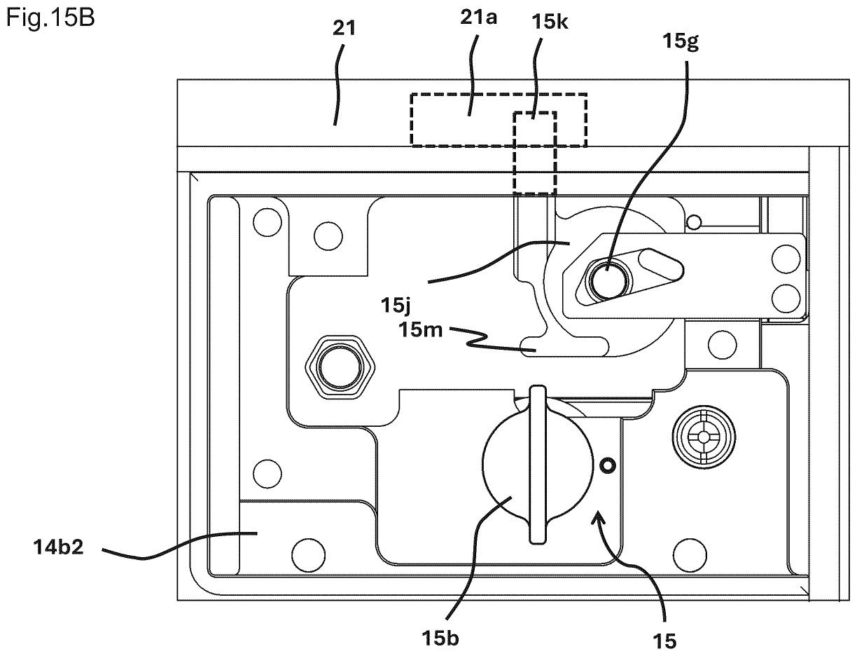

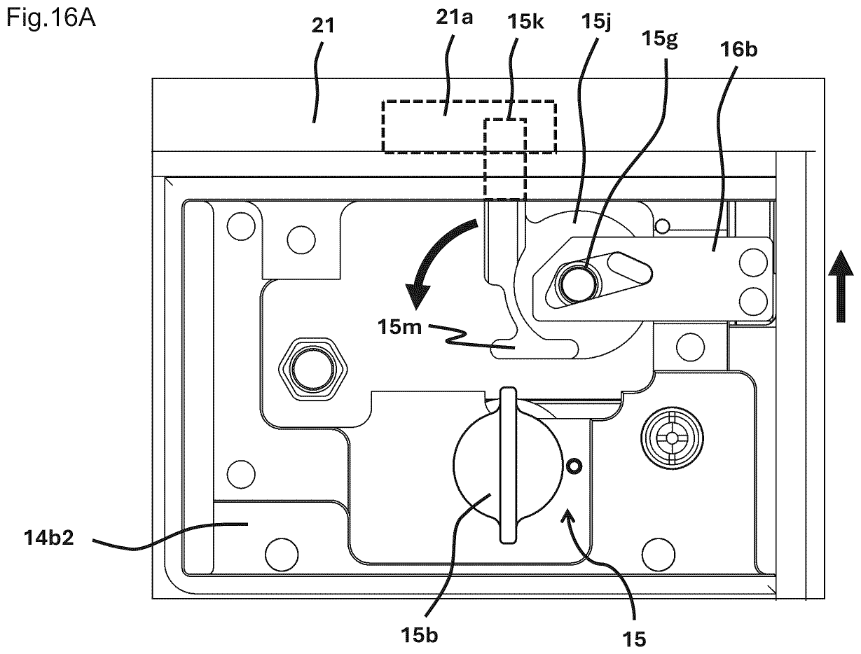

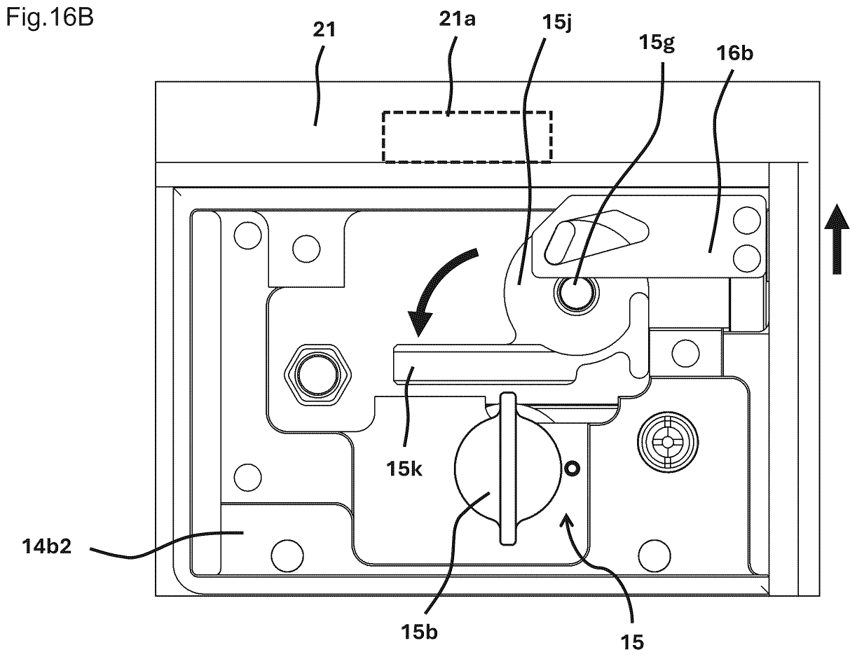

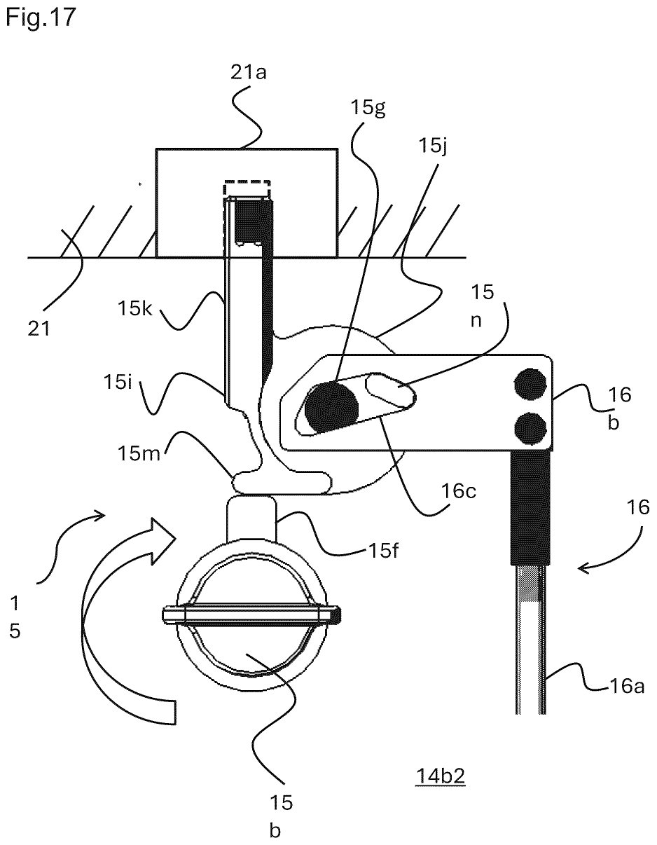

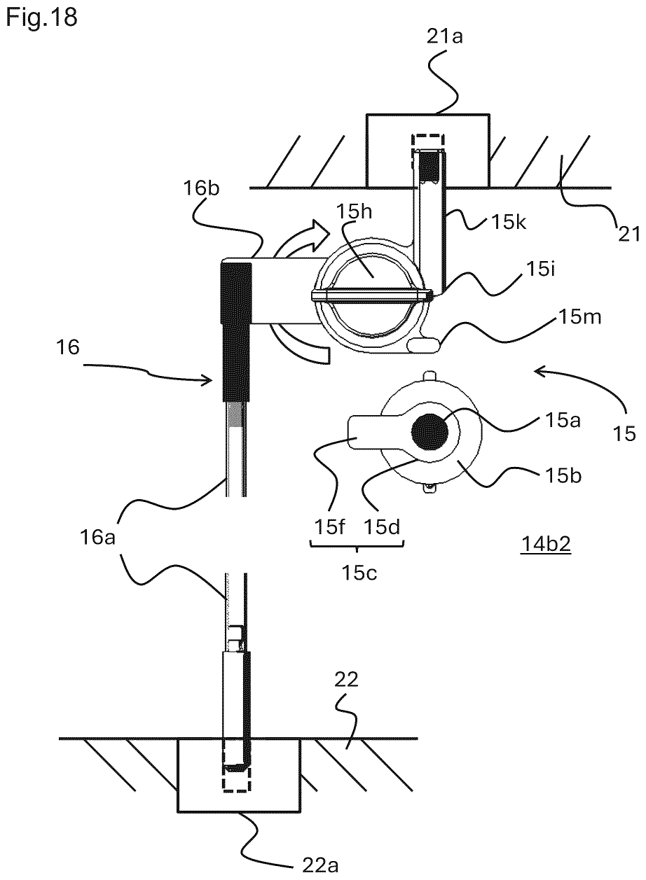

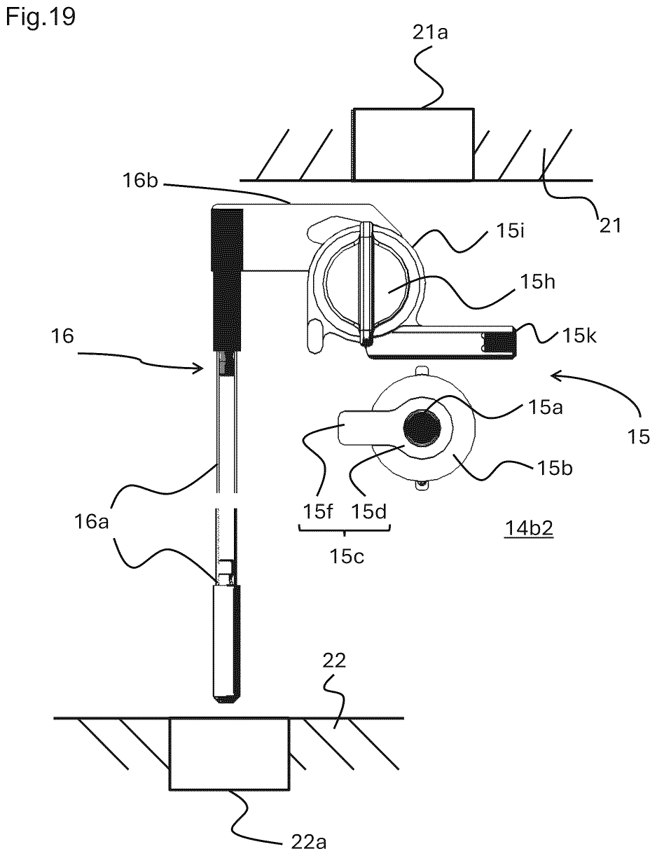

FIGS. 13 and 14 illustrate the first lock mechanism 15 arranged in a space on the inner side of the second panel 14b2 when viewed from the first lavatory compartment 11 side. FIGS. 15A, 15B, 16A, and 16B illustrate the first lock mechanism 15 arranged in a space on the inner side of the second panel 14b2 when viewed from the second lavatory compartment 12 side. FIG. 17 is a view schematically illustrating the first lock mechanism 15 viewed from the second lavatory compartment 12 side, and FIGS. 18 and 19 are views schematically illustrating the first lock mechanism 15 and the second lock mechanism 16 viewed from the first lavatory compartment 11 side.

In FIGS. 17 to 19, the first lock mechanism 15 includes a pivot shaft 15a that may pivot with respect to the second panel 14b2, a front side handle 15b fixed to the pivot shaft 15a on the second lavatory compartment 12 side, and a locking portion 15c that pivots together with the front side handle 15b. The locking portion 15c includes a disk shaped base portion 15d, and a protruded portion 15f that protrudes to a radial direction from the base portion 15d. The front side handle 15b and the locking portion 15c constitute a first operation member.

Further, the first lock mechanism 15 includes a pivot shaft 15g that is disposed in a shifted manner toward the ceiling 21 side from the pivot shaft 15a and that may pivot with respect to the second panel 14b2, a back-side handle 15h fixed to the pivot shaft 15g on the first lavatory compartment 11 side, and a lock portion 15i that pivots together with the back-side handle 15h. The lock portion 15i includes a disk shaped base portion 15j, an engagement key 15k that extends in an elongated manner from the base portion 15j to a tangential direction of an outer circumference, and a hook portion 15m that extends in a short manner to the tangential direction of an outer circumference at a 90-degree phase with respect to the engagement key 15k. A bump portion 15n that protrudes in an axial direction of the pivot shaft 15g is formed on the base portion 15j. An engagement recess portion 21a having a slit shape is formed on the ceiling 21 in correspondence with the engagement key 15k. The back-side handle 15h and the lock portion 15i constitute a second operation member, and the engagement key 15k constitutes a locking portion. The second operation member may include a link plate 16b and a rod 16a described below.

The second lock mechanism 16 includes the rod 16a that extends in the interior of the first panel 14b1 along the height direction of the first panel 14b1, and the link plate 16b fixed and connected to an upper end of the rod 16a. The link plate 16b includes a long hole 16c formed to extend away from the rod 16a. The pivot shaft 15g and the bump portion 15n are accommodated relatively movably within the long hole 16c, and according to a rotation angle of the base portion 15j, the bump portion 15n pushes the inner circumference of the long hole 16c, and thereby, the rod 16a may be lifted and lowered through the link plate 16b. An engagement recess portion 22a having a slit shape is formed on the floor 22 in correspondence with the lower end of the rod 16a.

The first lock mechanism 15 and the second lock mechanism 16 are interlocked. The interlocked state will be described in detail. As illustrated in FIG. 18, in a state where the back-side handle 15h is pivoted to a position where the engagement key 15k enters the engagement recess portion 21a, i.e., lock position, the hook portion 15m is in a horizontal state. In such a state, the rod 16a descends via the link plate 16b, and the lower end thereof enters the engagement recess portion 22a (FIG. 11). That is, the first lock mechanism 15 and the second lock mechanism 16 are in a locked state, and the first panel 14b1 will be in a locked state locked to the ceiling 21 and the floor 22.

In the locked state, as illustrated in FIG. 17, the front side handle 15b may be pivoted such that the protruded portion 15f points directly above. Then, a tip of the protruded portion 15f abuts against a side edge of the hook portion 15m, and thereby, the base portion 15j and the back-side handle 15h will no longer pivot toward the direction to be released from the locked state. In other words, by pivoting the front side handle 15b to the position illustrated in FIG. 17, the locked state of the first lock mechanism 15 and the second lock mechanism 16, i.e., an engaged state in which the first operation member is engaged with the second operation member, will be maintained, and the back-side handle 15h may not be pivoted unless the front side handle 15b is pivoted, such that the locked state of the first lock mechanism 15 and the second lock mechanism 16 will not be released.

Meanwhile, when the front side handle 15b is pivoted to a position illustrated in FIG. 18, the tip of the protruded portion 15f points to the horizontal direction, and the protruded portion 15f is separated from a side edge of the hook portion 15m, i.e., a separated state in which the first operation member is separated from the second operation member, such that the back-side handle 15h may be pivoted to the position illustrated in FIG. 19. Thereby, the engagement key 15k pivots and moves to a position separated from the engagement recess portion 21a, i.e., unlock position, and the rod 16a is lifted to an unlocked state separated from the engagement recess portion 22a (FIG. 12). In such a state, the second panel 14b2 becomes relatively movable with respect to the ceiling 21 and the floor 22. From the viewpoint of preventing erroneous operation, when the engagement key 15k is separated from the engagement recess portion 21a, even if the front side handle 15b is attempted to be returned from the position illustrated in FIG. 19 to the position illustrated in FIG. 17, the protruded portion 15f may be made to interfere with the engagement key 15k such that the front side handle 15b will not return to position. That is, the first operation member may be enabled to shift from the separated state to the engaged state only when the locking portion is at the lock position.

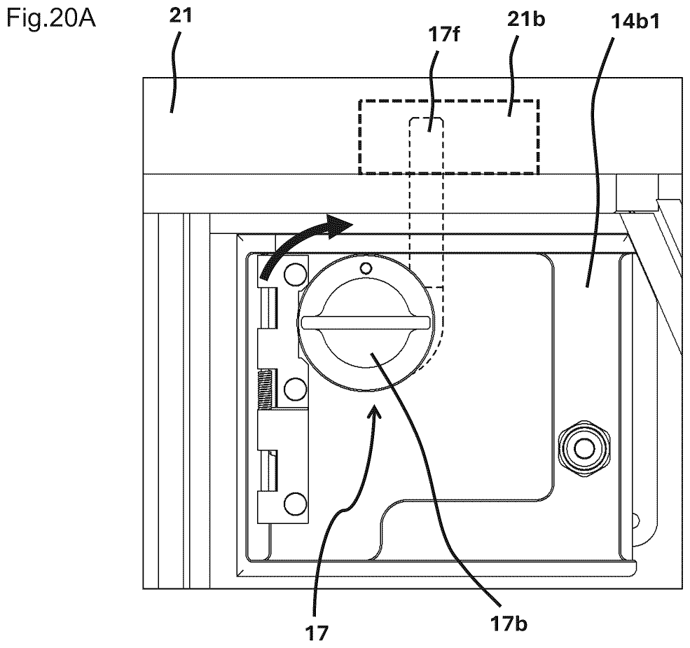

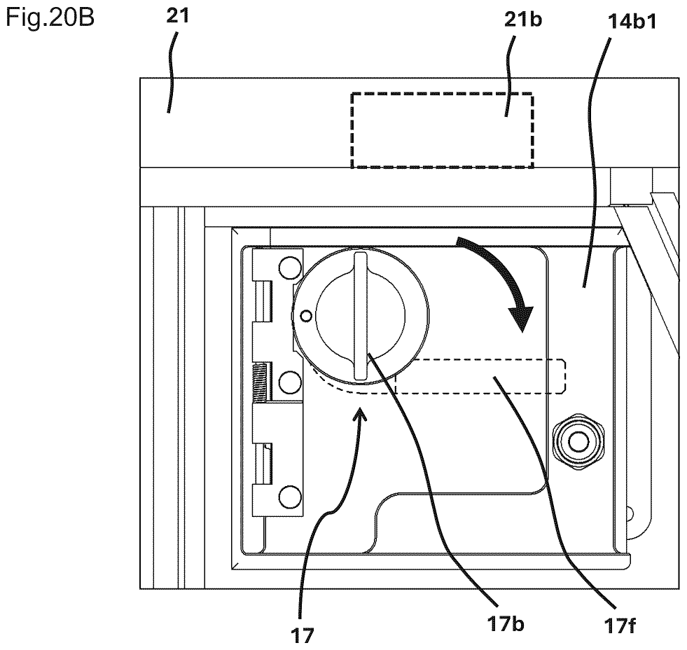

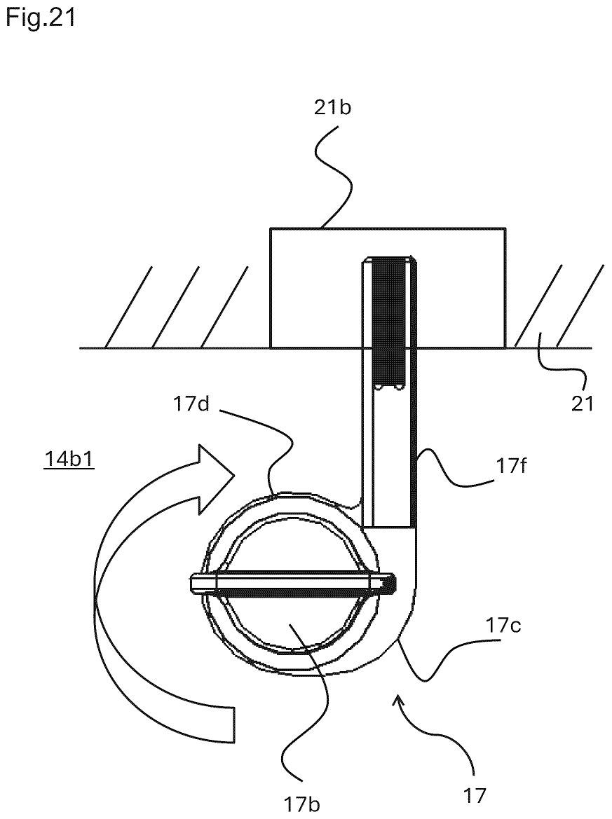

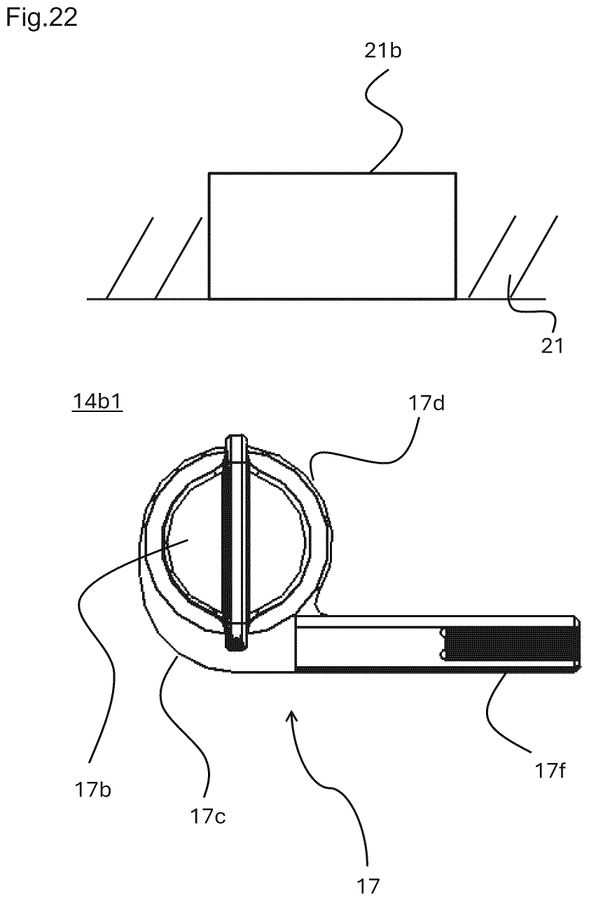

FIGS. 20A and 20B are views illustrating the third lock mechanism 17 arranged within the space on the inner side of the first panel 14b1 viewed from the second lavatory compartment 12 side. FIGS. 21 and 22 are views schematically illustrating the third lock mechanism 17 viewed from the second lavatory compartment 12 side.

FIGS. 21 and 22, the third lock mechanism 17 includes a pivot shaft (not shown) capable of pivoting with respect to the first panel 14b1, a handle 17b fixed to the pivot shaft on the second lavatory compartment 12 side, and a cam portion 17c that pivots together with the handle 17b. The cam portion 17c includes a disk shaped base portion 17d, and an engagement key 17f that extends from the base portion 17d in a tangential direction of an outer circumference. In response to the engagement key 17f, a slit shaped engagement recess portion 21b is formed on the ceiling 21.

When the handle 17b is pivoted to the position illustrated in FIG. 21, a tip of the engagement key 17f points directly above, and enters the engagement recess portion 21b. Thereby, the first panel 14b1 will be relatively unmovable with respect to the ceiling 21. Meanwhile, in a state where the handle 17b is pivoted to the position illustrated in FIG. 22, the engagement key 17f points to the horizontal direction and separates from the engagement recess portion 21b, such that the first panel 14b1 will be relatively movable with respect to the ceiling 21.

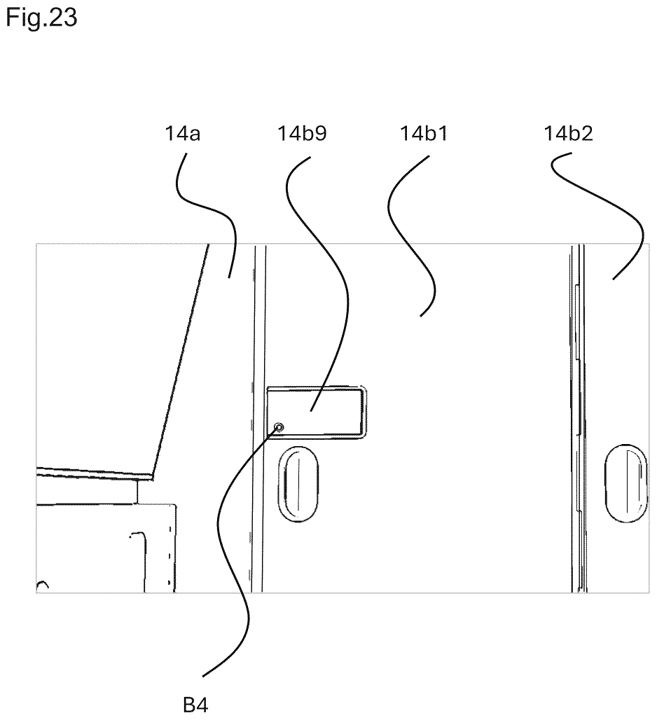

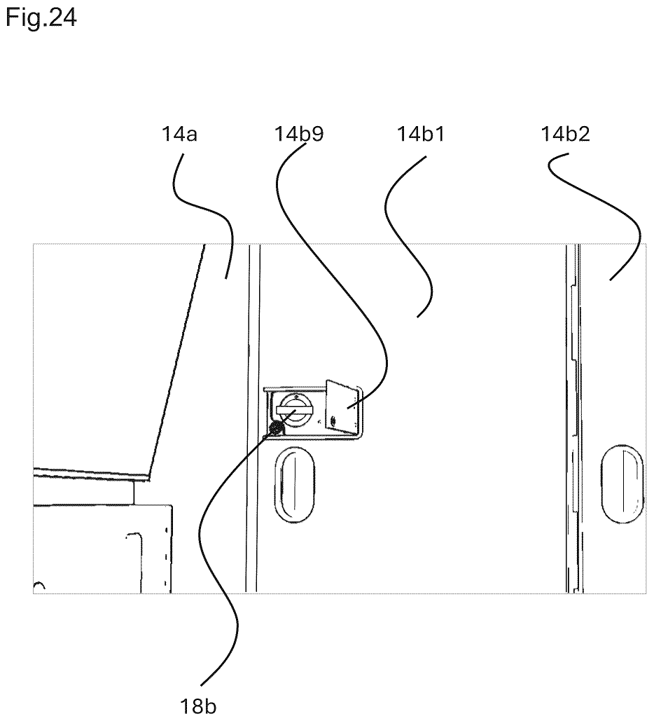

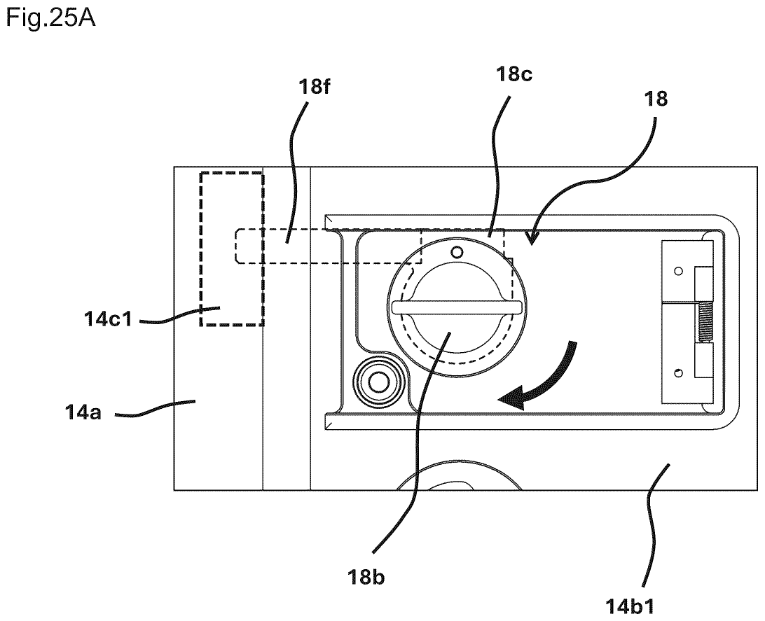

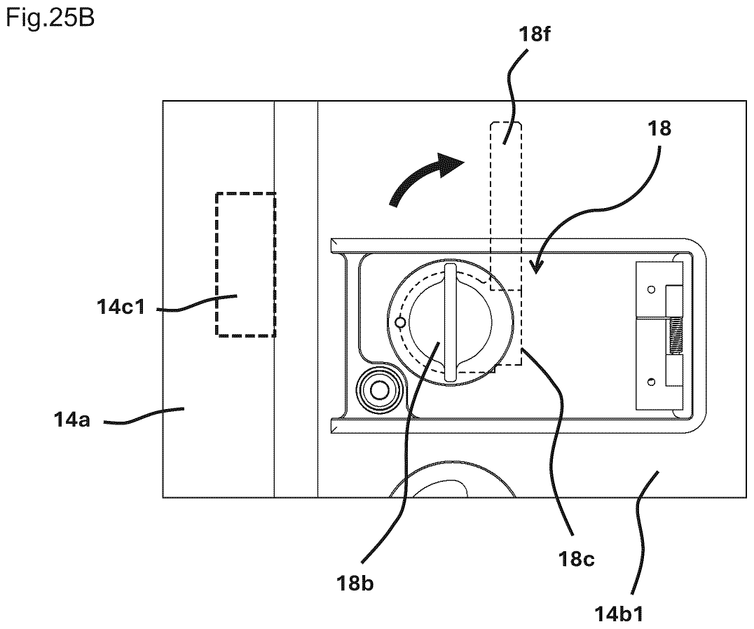

FIGS. 23 and 24 are enlarged views illustrating a vicinity of a center of a side portion of the movable wall 14b viewed from the first lavatory compartment 11 side. FIGS. 25A and 25B are views illustrating the fourth lock mechanism 18 arranged in a space on the inner side of the first panel 14b1 viewed from the first lavatory compartment 11 side.

The first panel 14b1 has a small-sized fourth access door 14b9 near a side edge adjacent to the supporting wall 14c on the first lavatory compartment 11 side. By pushing a button B4, a locking mechanism not shown is released, and the fourth access door 14b9 will be in an open state as illustrated in FIG. 24 with respect to the first panel 14b1, such that cabin attendants etc. may access the interior thereof. Meanwhile, by closing the fourth access door 14b9 with respect to the first panel 14b1 and pushing the button B4, the locking mechanism is activated, and cabin attendants etc. may not access the interior thereof. The fourth lock mechanism 18 is arranged in a space on the inner side of the fourth access door 14b9.

The fourth lock mechanism 18 adopts a similar configuration as the third lock mechanism 17. More specifically, in FIGS. 25A and 25B, the fourth lock mechanism 18 includes a pivot shaft (not shown) that may pivot with respect to the first panel 14b1, a handle 18b fixed to the pivot shaft on the first lavatory compartment 11 side, and a cam portion 18c that pivots together with the handle 18b. The cam portion 18c includes an engagement key 18f that extends in a tangential direction of an outer circumference. A slit shaped engagement recess portion 14c1 is formed on the fixed wall 14a in correspondence with the engagement key 18f. The engagement key 18f has an anchor shaped tip, and the anchor shaped tip is preferably enabled to enter to or recede from a transverse groove formed to the interior of the engagement recess portion 14c1 along with the rotational movement.

In a state where the handle 18b is pivoted to a position illustrated in FIG. 25A, the engagement key 18f heads toward the horizontal direction, and enters the engagement recess portion 14c1. Thereby, the second panel 14b2 is disabled from relatively moving with respect to the fixed wall 14a. Meanwhile, when the handle 18b is pivoted to the position illustrated in FIG. 25B, the engagement key 18f is pointed directly above and separates from the engagement recess portion 14c1, such that the first panel 14b1 is enabled to move relatively with respect to the fixed wall 14a.

### (Operation of Lock Mechanism)

Next, an operation of the respective lock mechanisms according to the present embodiment will be descried. At first, in a position, i.e., closed position, where the movable wall 14b is abutted against the fixed wall 14a of the intermediate wall 14, as illustrated in FIG. 2, an outer edge of the movable wall 14b is in close contact without any gap with the fixed wall 14a, the ceiling 21, the floor 22, and the supporting wall 14c, as illustrated in FIG. 6. Thereby, the first lavatory compartment 11 and the second lavatory compartment 12 each constitute a closed chamber space that are partitioned by the intermediate wall 14 and that ensure privacy. Therefore, by opening each of the lavatory doors 11f and 12f, two passengers may enter the first lavatory compartment 11 and the second lavatory compartment 12 simultaneously, and by closing the lavatory doors 11f and 12f, the compartments may respectively be used independently, such that both privacy and convenience of passengers may be ensured.

Meanwhile, the spaces within each of the lavatory doors 11f and 12f are relatively small, such that it is difficult for a passenger on a wheelchair to enter the space and move from the wheelchair to the toilet bowl. Therefore, according to the present embodiment, the movable wall 14b of the intermediate wall 14 may be moved to open the space between the first lavatory compartment 11 and the second lavatory compartment 12 to create a wide space. By connecting the spaces of the first lavatory compartment 11 and the second lavatory compartment 12, the passenger that enters the first lavatory compartment 11 on a wheelchair may move beyond the intermediate wall 14a and move from the wheelchair to the toilet bowl 12b.

However, if any of the passengers may open the intermediate wall 14, there is a risk that the intermediate wall 14 may be opened erroneously, such that privacy may not be ensured. It may be possible to lock the intermediate wall 14 during normal use, and when necessary, a cabin attendant may get a key stored elsewhere to open the lock. However, there is a need to store the key for opening the lock at a position where normal passengers may not access, such that it is troublesome to retrieve the key from the storage location to open the lock.

In contrast, according to the present embodiment, by having a cabin attendant, or a helper assisting the passenger using the wheelchair, remember the necessary lock releasing procedure, the intermediate wall 14 may be easily set to the open state, while there is no risk of having general passengers that do not have the knowledge of the lock releasing procedure open the intermediate wall 14, such that privacy may be ensured. The opening state of the intermediate wall 14 will be described below.

As illustrated in FIG. 2, in a state where the movable wall 14b is in contact with the fixed wall 14a, the first lock mechanism 15, the second lock mechanism 16, the third lock mechanism 17, and the fourth lock mechanism 18 are all in a locked state.

From such a locked state, for example, after confirming that both the first lavatory compartment 11 and the second lavatory compartment 12 are not used, a cabin attendant serving as an operator may enter the second lavatory compartment 12, push the buttons B1 and B2 illustrated in FIG. 7, and open the first access door 14b5 and the second access door 14b6 to a state as illustrated in FIG. 8.

By opening the first access door 14b5, the front side handle 15b of the first lock mechanism 15 behind the first access door 14b5 may be accessed, such that the cabin attendant may operate the front side handle 15b and pivot the same in a clockwise direction from the state illustrated in FIGS. 15A and 17 to the state illustrated in FIGS. 15B and 18. Thereby, the protruded portion 15f is separated from the hook portion 15m. Even when the first access door 14b5 is opened, the back-side handle 15h may not be accessed from the second lavatory compartment 12. Therefore, the first lock mechanism 15 and the second lock mechanism 16 are maintained in a locked state.

Further, by opening the second access door 14b6, the handle 17b of the third lock mechanism 17 behind the second access door 14b6 may be accessed, such that the cabin attendant may operate the handle 17b and pivot the same in a clockwise direction from the state illustrated in FIG. 13 to the state illustrated in FIG. 14. Thereby, the engagement key 17f is separated from the engagement recess portion 21b, such that the lock of the third lock mechanism 17 is released. Thereafter, the cabin attendant returns the first access door 14b5 and the second access door 14b6 to their original states.

Next, the cabin attendant may leave the second lavatory compartment 12 and enter the first lavatory compartment 11, press the button B3 illustrated in FIG. 9, and open the third access door 14b7 as illustrated in FIG. 10.

By opening the third access door 14b7, the back-side handle 15h of the first lock mechanism 15 behind the third access door 14b7 may be accessed, such that the cabin attendant may operate the back-side handle 15h and pivot the same in a clockwise direction from the state illustrated in FIG. 18 to the state illustrated in FIG. 19. Thereby, the engagement key 15k is separated from the engagement recess portion 21a, and the lower end of the rod 16a is separated from the engagement recess portion 22a, such that the locks of the first lock mechanism 15 and the second lock mechanism 16 are released. Thereafter, the cabin attendant returns the third access door 14b7 to its original state.

Next, the cabin attendant presses the button B4 illustrated in FIG. 23, and opens the fourth access door 14b9 as illustrated in FIG. 24.

Furthermore, by opening the fourth access door 14b9, the handle 18b of the fourth lock mechanism 18 behind the fourth access door 14b9 may be accessed, such that the cabin attendant nay operate the handle 18b and pivot the same in a clockwise direction from the state illustrated in FIG. 25A to the state illustrated in FIG. 25B. Thereby, the engagement key 18f is separated from the engagement recess portion 14c1, such that the lock of the fourth lock mechanism 18 is released. Thereafter, the cabin attendant returns the fourth access door 14b9 to its original state.

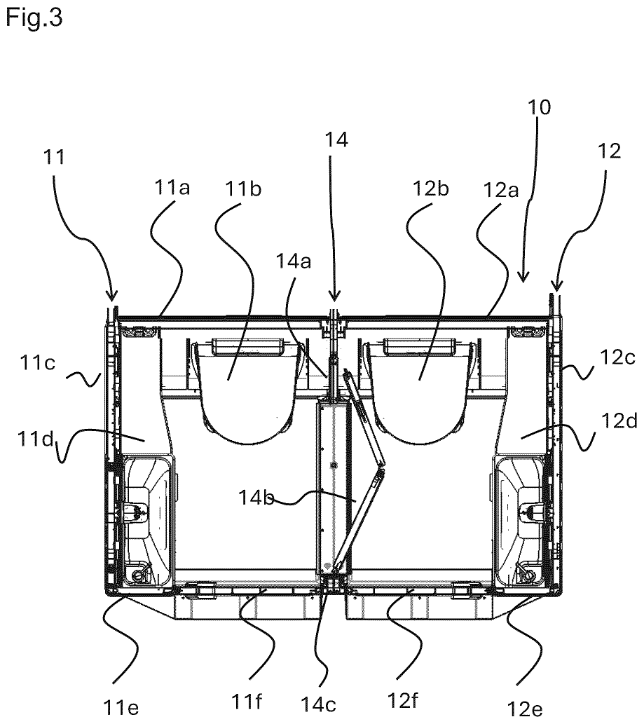

By the operations described above, the first lock mechanism 15, the second lock mechanism 16, the third lock mechanism 17, and the fourth lock mechanism 18 are all in a lock released state. The cabin attendant may push the movable wall 14b in the lock released state from the first lavatory compartment 11 side toward the second lavatory compartment 12 and fold the movable wall 14b as illustrated in FIGS. 3 to 5, according to which the space between the fixed wall 14a and the supporting wall 14c may be opened.

In this state, the lavatory door 12f of the second lavatory compartment 12 will be adjacent to the folded movable wall 14b, but the first lavatory compartment 11 may be accessed through the lavatory door 11f of the first lavatory compartment 11. Therefore, after the cabin attendant leaves the first lavatory compartment 11, the passenger on the wheelchair may enter the first lavatory compartment 11 through the opened lavatory door 11f. After moving off from the wheelchair, the passenger may pass the space between the fixed wall 14a and the supporting wall 14c to move to the second lavatory compartment 12 and sit on the toilet bowl 12b. The lavatory door 11f may be closed by the cabin attendant, such that a wide space formed by connecting the first lavatory compartment 11 and the second lavatory compartment 12 will be in a locked state, and privacy can be ensured.

When the passenger wishes to leave the compartment, the passenger may move from the toilet bowl 12b to the wheelchair placed in the first lavatory compartment 11, and leave the first lavatory compartment 11 through the lavatory door 11f opened by the cabin attendant while riding on the wheelchair. Thereafter, the cabin attendant may return the movable wall 14b to a state aligned with the fixed wall 14a and the supporting wall 14c as illustrated in FIG. 2, and operate the first lock mechanism 15, the second lock mechanism 16, the third lock mechanism 17, and the fourth lock mechanism 18 in an opposite procedure as when releasing the lock, to return them to the locked state. It is clear that if the movable wall 14b is not moved to the closed position illustrated in FIG. 2, the engagement key 15k may not be engaged with the engagement recess portion 21a, the lower end of the rod 16a may not be engaged with the engagement recess portion 22a, the engagement key 17f may not be engaged with the engagement recess portion 21b, and the engagement key 18f may not be engaged with the engagement recess portion 14c1, such that the handles that are interlocked therewith may not be returned to their original positions.

According to the present embodiment, when used by a general passenger, the first lavatory compartment 11 and the second lavatory compartment 12 may be used independently, whereas when used by a passenger on a wheelchair, the movable wall 14b may be folded to create a wide space in which the first lavatory compartment 11 and the second lavatory compartment 12 are connected. Thereby, efficient use of the limited space one the aircraft 1 may be realized, and the convenience of passengers may be ensured.

According to the present embodiment, the movable wall 14b may not be moved at least if the lock releasing procedures of the first lock mechanism 15 and the second lock mechanism 16 are not known, such that the passengers will not move the movable wall 14b by mistake, and the privacy in the first lavatory compartment 11 and the second lavatory compartment 12 may be ensured.

The present invention is not limited to the above embodiments. For example, the lock mechanism may also be released by reversing the intermediate wall 14 and having the cabin attendant perform the operation on the first lavatory compartment 11 side before performing operation on the second lavatory compartment 12 side. Further, it may be possible to provide the first lock mechanism 15 and only either the third lock mechanism 17 or the fourth lock mechanism 18.

The present specification contains disclosure of the following inventions.

### (First Aspect)

A lavatory compartment structure of an aircraft characterized in including:
a first lavatory compartment surrounded by a first housing;
a second lavatory compartment adjacent to the first lavatory compartment and surrounded by a second housing;
a movable wall that is movable between a closed position of closing a space between the first lavatory compartment and the second lavatory compartment and an open position of opening the space between the first lavatory compartment and the second lavatory compartment; and
a main lock mechanism of the movable wall,
wherein the first housing and the second housing constitute a lavatory housing,
wherein the main lock mechanism includes:
a first operation member that is operable from one side of either the first lavatory compartment or the second lavatory compartment;
a second operation member that is operable from the other side of the first lavatory compartment or the second lavatory compartment; and
a locking portion connected to the second operation member and that is movable between a lock position preventing movement of the movable wall with respect to the lavatory housing, and an unlock position enabling movement of the movable wall with respect to the lavatory housing,
wherein, by operating the first operation member, the first operation member may be shifted to either an engaged state in which the first operation member is engaged to the second operation member or a separated state in which the first operation member is separated from the second operation member, and
wherein, in the engaged state, the second operation member may not be operated to move the locking portion from the lock position to the unlock position, and in the separated state, the second operation member may be operated to move the locking portion from the lock position to the unlock position.

### (Second Aspect)

The lavatory compartment structure of an aircraft according to aspect 1,
wherein, when the locking portion is at the lock position, the first operation member may be shifted from the separated state to the engaged state.

### (Third Aspect)

The lavatory compartment structure of an aircraft according to aspect 1 or aspect 2,
wherein the movable wall has access doors that may be opened and closed arranged on both sides thereof, and the main lock mechanism is disposed between the pair of access doors, and
wherein by opening one of the access doors, an operator may access the first operation member, and by opening the other one of the access doors, the operator may access the second operation member.

### (Fourth Aspect)

The lavatory compartment structure of an aircraft according to any one of aspects 1 to 3,
wherein the first operation member includes a front side handle that may be operated to rotate, and a protruded portion that rotates together with the front side handle,
wherein the second operation member includes a back-side handle that may be shifted with respect to a rotation shaft of the front side handle and that may be operated to rotate, and a hook portion that rotates together with the back-side handle,
wherein the locking portion is an engagement key that rotates together with the back-side handle and that may be engaged with and separated from an engagement recess portion of the lavatory housing, and
wherein the front side handle is rotated to have the protruded portion abut against the hook portion to be shifted to the engaged state, and to have the protruded portion separate from the hook portion to be shifted to the separated state.

### (Fifth Aspect)

The lavatory compartment structure of an aircraft according to the fourth aspect,
wherein the second operation member further includes a link plate connected to the back-side handle, and a rod connected to the link plate, and
wherein the rod is moved to an axial direction by a drive force transmitted via the link plate by the rotation of the back-side handle, and may be engaged with and disengaged from an engagement recess portion of the lavatory housing positioned on an opposite side as the locking portion in an up-down direction interposing the movable wall.

### (Sixth Aspect)

The lavatory compartment structure of an aircraft according to any one of aspects 1 to 5,
wherein the movable wall is arranged between a fixed wall and a supporting wall connected to the lavatory housing, the movable wall including a first panel, and a second panel that may be pivoted with respect to the first panel, wherein the second panel is connected in a pivotable manner to the supporting wall.

### (Seventh Aspect)

The lavatory compartment structure of an aircraft according to aspect 6,
wherein the main lock mechanism is disposed on the second panel, and a sub-lock mechanism that prevents relative movement of the first panel with respect to the lavatory housing is disposed on the first panel in a manner independent from the main lock mechanism.

### DESCRIPTION OF THE REFERENCE NUMERAL

1 aircraft
2 seat unit
3 vertical aisle
4 aircraft body door
10 lavatory compartment structure
11 first lavatory compartment
12 second lavatory compartment
14 intermediate wall
15 first lock mechanism
16 second lock mechanism
17 third lock mechanism
18 fourth lock mechanism
21 ceiling
22 floor

1. A lavatory compartment structure of an aircraft comprising:
a first lavatory compartment surrounded by a first housing;
a second lavatory compartment adjacent to the first lavatory compartment and surrounded by a second housing;
a movable wall that is movable between a closed position of closing a space between the first lavatory compartment and the second lavatory compartment and an open position of opening the space between the first lavatory compartment and the second lavatory compartment; and
a main lock mechanism of the movable wall,
wherein the first housing and the second housing constitute a lavatory housing,
wherein the main lock mechanism includes:
a first operation member that is operable from one side of either the first lavatory compartment or the second lavatory compartment;
a second operation member that is operable from the other side of the first lavatory compartment or the second lavatory compartment; and
a locking portion connected to the second operation member and that is movable between a lock position preventing movement of the movable wall with respect to the lavatory housing, and an unlock position enabling movement of the movable wall with respect to the lavatory housing,
wherein, by operating the first operation member, the first operation member may be shifted to either an engaged state in which the first operation member is engaged to the second operation member or a separated state in which the first operation member is separated from the second operation member, and
wherein, in the engaged state, the second operation member may not be operated to move the locking portion from the lock position to the unlock position, and in the separated state, the second operation member may be operated to move the locking portion from the lock position to the unlock position.

2. The lavatory compartment structure of an aircraft according to claim 1,
wherein, when the locking portion is at the lock position, the first operation member may be shifted from the separated state to the engaged state.

3. The lavatory compartment structure of an aircraft according to claim 1,
wherein the movable wall has access doors that may be opened and closed arranged on both sides thereof, and the main lock mechanism is disposed between the pair of access doors, and
wherein by opening one of the access doors, an operator may access the first operation member, and by opening the other one of the access doors, the operator may access the second operation member.

4. The lavatory compartment structure of an aircraft according to claim 1,
wherein the first operation member includes a front side handle that may be operated to rotate, and a protruded portion that rotates together with the front side handle,
wherein the second operation member includes a back-side handle that may be shifted with respect to a rotation shaft of the front side handle and that may be operated to rotate, and a hook portion that rotates together with the back-side handle,
wherein the locking portion is an engagement key that rotates together with the back-side handle and that may be engaged with and separated from an engagement recess portion of the lavatory housing, and
wherein the front side handle is rotated to have the protruded portion abut against the hook portion to be shifted to the engaged state, and to have the protruded portion separate from the hook portion to be shifted to the separated state.

5. The lavatory compartment structure of an aircraft according to claim 4,
wherein the second operation member further includes a link plate connected to the back-side handle, and a rod connected to the link plate, and
wherein the rod is moved to an axial direction by a drive force transmitted via the link plate by the rotation of the back-side handle, and may be engaged with and disengaged from an engagement recess portion of the lavatory housing positioned on an opposite side as the locking portion in an up-down direction interposing the movable wall.

6. The lavatory compartment structure of an aircraft according to claim 1,
wherein the movable wall is arranged between a fixed wall and a supporting wall connected to the lavatory housing, the movable wall including a first panel, and a second panel that may be pivoted with respect to the first panel, wherein the second panel is connected in a pivotable manner to the supporting wall.

7. The lavatory compartment structure of an aircraft according to claim 6,
wherein the main lock mechanism is disposed on the second panel, and a sub-lock mechanism that prevents relative movement of the first panel with respect to the lavatory housing is disposed on the first panel in a manner independent from the main lock mechanism.
